(19) United States
(12) Patent Application Publication
(10) Pub. No.: US 2004/0035349 A1
(43) Pub. Date: Feb. 26, 2004

(54) Reelable solid marine fairing

(75) Inventor: Glen P. Barker, Friendswood, TX (US)

Correspondence Address: CONLEY ROSE, P.C., P. O. BOX 3267, HOUSTON, TX, 77253-3267, US

(73) Assignee: Veritas DGC, Inc., Houston, TX

(21) Appl. No.: 10/226,852

(22) Filed: Aug. 23, 2002

(51) Int. Cl. F15D 1/10

(52) U.S. Cl. 114/243

(57) ABSTRACT

A marine fairing combining the benefits of flexible and rigid fairings. The preferred fairing is made from a material that makes the fairing rigid enough to achieve the superior hydrodynamic performance of rigid fairings, but flexible enough to resist permanent deformation when stored on cables that are reeled onto drums for storage. The material preferably is BASF Elastollan® 1185A, 1995A or other suitable polyether-based thermoplastic polyurethane.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention generally relates to marine seismology, in which a moving ship generates seismic waves and detects reflections, and in particular to improving the hydrodynamics of cables towed behind these ships. Still more particularly, the invention relates to a solid shape fairing that attaches to marine cables or ropes to reduce drag and strumming effects, reduce the spreading force required to deploy the cables at a lateral offset from the seismic vessel, save fuel and increase efficiency.

2. Background Information

Most oil companies rely on seismic interpretation to select sites for drilling exploratory oil wells. Seismic data acquisition is routinely performed both on land and at sea. At sea, a seismic ship deploys a streamer or cable behind the ship as the ship moves forward. Multiple receivers are typically towed behind the ship on streamners in an array. Streamers typically include a plurality of receivers. A seismic source is also towed behind the ship, with both the source and receivers typically deployed below the surface of the ocean. Streamers typically include electrical or fiber-optic cabling for interconnecting receivers and seismic equipment on the ship.

Streamers are usually constructed in sections 25 to 100 meters in length and include groups of up to 35 or more uniformly spaced receivers. The streamers may be several miles long, and often a seismic ship trails multiple streamers, with a uniform lateral separation between the streamers, to increase the amount of seismic data collected. Operating at a typical production speed of 4 to 5 knots and towing in excess of 50 tons of instrument-laden equipment in the water, drag is a major issue limiting the efficiency of a seismic ship. Similarly, the number and length of streamers to be deployed, as well as the lateral separation to be maintained between streamers, dictates the size of diverters, or paravanes, that must be deployed with the array, which in turn also has a major impact on the efficiency of the seismic ship.

The amount of equipment towed behind a ship is generally dictated by the requirements of the job. The equipment and cables being towed create a drag on the ship. The more equipment and cables that are towed behind a ship, the more drag is created, and the more lateral spreading force is required to achieve desired separations between cables. This results undesirably in higher fuel consumption, higher stresses in cables and rigging components, and greater lengths of deployed cables needed to achieve required lateral separations. In addition to seismic ships, other marine vessels, such as defense vessels, oceanographic ships and commercial fishing boats also may tow cabling or equipment for which hydrodynamic improvements would be beneficial.

FIGS. 1A and 1B show side and front views, respectively, of ship 10 moving through the water 11 in direction 12 and towing a cable 13, which has a lateral offset w with respect to the direction of travel 12. Objects being towed through water have an inherent drag force 14 and lateral lift force 99 acting against them, due to friction and pressure forces discussed below. The total drag force 14 and lateral lift force 99 can be reduced by several methods, including varying the shape, smoothness or frontal (or projected) area 15 of an object exposed to oncoming water flow, where frontal area is a function of cable width x and length L of deployed cable below the waterline.

As noted above, seismic ships routinely pull hundreds of meters of cable behind them. Cables naturally tend to sag toward the ocean floor when held at endpoints, defining a catenary 16, or curve, that is dependent upon the cable width x, cable density, and drag acting on the cable. The catenary 16 includes the lateral curve of the cable resulting from its displacement w off of the ship's centerline, and is influenced by the cable width x, cable density, and lateral lift force 99 acting on the cable 13.

FIG. 2A depicts the streamlines 20, or fluid path, that would result around a cylinder 13 oriented perpendicularly to the cylinder's direction of travel 12 through the fluid, if the fluid conformed to an idealized potential flow theory of a fluid with no viscosity. In this idealized case, flow along the streamline 20 coincident with the cylinder's centerline 101 will come to rest at the stagnation point 102, creating the stagnation pressure along the entire leading edge 19 of cylinder 13.

Flow along the converging streamlines 20 on either side of centerline 101 will accelerate as the flow moves to the top 21 and bottom 22 points of maximum circular cross-section, for which pressure will reach its minimum value. Pressure recovery then occurs as the flow continues along the diverging streamlines 20, aft of the cyliider's transverse centerline 25. If the fluid flow around cylinder 13 behaved according to the idealized potential flow theory, pressure in front and in back of cylinder 13 would be substantially equal, there would be no pressure difference acting on the cable, and therefore, no pressure drag.

In reality, potential flow theory does not hold true for reasons to be explained below. Referring now to FIG. 2B, behind the plane 25 of the cable's maximum diameter, pressure of water 11 flowing over the cable 13 will increase in the direction of fluid flow 26, as the streamlines 20 that were “squeezed” together at the maximum diameter 25 begin to flow around the rear side 23 of the cable 13 and are free to expand once more. Due to this pressure increase, a net pressure force 27 in the opposite direction acts on the fluid 11, opposing its flow. At some point, the momentum of the fluid 11 close to the cable 13 is not enough to oppose this retarding force 27, so the streamlines 20 close to the surface 28 of cable 13 slow down and separate from the surface 28. The flow streamlines 20 can no longer easily “hug” the object's surface 28, and a violent disruption of the flow orcurs. This event is called “flow separation.”

When flow separation occurs, a relatively low-pressure region of wake turbulence 29, is created behind the cable 13, where the fluid 11 lacks the momentum to flow on in smooth layers 20. Turbulence is characterized as random, disorganized and unpredictable flow. This region of wake turbulence 29 behind the cable 13 creates a retarding force, or pressure drag 27, on the object, inhibiting its movement through the fluid 11. The greater the size of the wake 29, the greater the pressure drag 27. As previously mentioned, total drag 14 is a combination of pressure drag 27 and drag forces incurred by friction (not shown).

Since the sudden pressure rise seen on the rear of the object leads to flow separation, which creates wake turbulence 29, it follows that spreading this pressure rise over a greater distance would delay the onset of flow separation and, hence, decrease the pressure drag 27 incurred by the object. One way to achieve this would be to streamline the rear section of the object being towed into a teardrop or airfoil shape, as shown in FIG. 3. Much like an airplane wing traveling through air, an object 30 passing through water 11 will incur less pressure drag 27 if the pressure is allowed to slowly rise over the length of its body, delaying or much preventing flow separation, and thus, greatly reducing the associated wake 29 and opposing forces.

“Strumming,” illustrated in FIG. 4, is another phenomenon that increases drag in towed marine cables and can bring about fatigue failure in associated equipment. The flow of water 11 around the cable 13 produces the aforementioned wake 29, or eddies, which in turn produce strumming, an up-and-down oscillation 40 of the cable 13. Strumming increases drag as the cable 13 presents a larger effective area to the flow.

As mentioned previously, it is beneficial to maintain a uniform, target lateral separation between towed cables. Referring now to FIG. 5A, a ship 10 is shown towing a paravane assembly 42 and array of cables 13, with a tag line 43 maintaining proper lateral separations 46 between cables 13. Drag forces 14 and lateral lift forces 99 (not shown) acting on cables 13 and tag line 43 make it more difficult to tow the equipment and tend to push cables 13 closer together in a “streamlining” effect. As the drag and lift forces of water 11 push cables 13 closer together, tag line 43, which is perpendicular to the direction of travel 12, loses tautness and incurs a deflection 44 from a preferred straight position, making it difficult to maintain the desired lateral separation between cables 13.

Reducing drag 14 and lateral lift forces 99 (not shown) on cables 13 reduces the spreading force 45 (a force acting perpendicular to cables 13) needed to achieve the desired lateral separations 46 between cables 13, as shown in FIG. 5B. Consequently, tag lines 43 will remain straighter and have a smaller deflection 44. Therefore, reducing drag on a towed assembly reduces the forces on the assembly, making the assembly easier to tow, and allowing for longer or wider arrays or the deployment of additional cables.

There are several methods for improving the hydrodynamics of marine cables. One way is to attach one or more “fairings” to each cable. The fairing generally comprises a cover that is used to smooth the transition between the cable and water. Fairings are available in a variety of sizes and styles. Two main classifications of fairings are flexible fairings and rigid fairings. As described below, each has its respective advantages and disadvantages.

When not in use, marine cables are spooled onto large reels, or drums (not shown), on the ship, and flexible fairings offer the advantage that they can be left on the cable as it is reeled onto the drum, for easy storage. In general, flexible fairings will not damage adjacent cables due to their lack of rigidity. However, as they can flex by definition, flexible fairings can often develop a wave-like motion when in use, restricting the ease with which the cable can move through the water. The flexible fairings react to fluid momentum and pressure field effects, and a distorted fairing profile is produced, resulting in decreased drag reduction efficiency. Flexible fairings therefore tend to have a higher drag coefficient (Cd) than rigid fairings, indicating their higher resistance to move through the water. Moreover, flexible fairings are desirable for storage on drums, but offer less than desirable performance in use.

One example of a flexible fairing is the “hair” or “hairy” fairing 50, as shown in FIG. 6, which typically comprises a braided cable cover 51 threaded with hair-like string extensions 52. These “hairy” extensions 52 serve to disrupt the formation of coherent eddies in the wake region behind cable 13, thereby reducing the intensity of strumming which results from the shedding of strong regular vortices from alternate sides 53 and 54 of cable 13. While hairy fairings will not provide any drag reduction in general over a bare cylinder, they do serve to limit the extent to which an increase in drag will result from the onset of strumming. As the hairy fairing 50 is extremely flexible, it is very easy to store and requires no removal from the cables prior to cable storage on the drum. Furthermore, it offers a drag coefficient ranging from approximately 1.2 for a new hairy fairing to 1.5 for a worn hairy fairing. This is significantly smaller than a drag coefficient of approximately 2.0 for a bare cable in the presence of intense strumming, but lower drag coefficients would be even more desirable.

However, as the hairy fairing 50 comprises numerous independent string-like extensions 52, these extensions 52 will suffer wear and degradation in effectiveness over time. Additionally, the braided jacket 51 that is applied over cable 13 to produce hairy strands 52 contributes to a small increase in cable cross section, as well as an increase in surface roughness, both of which can lead to a net increase in drag.

A second type of flexible fairing is a “flag” fairing 60, marketed, for example, by Odim-Spectrum under the trade name TufLine, and shown in FIG. 7. The flag fairing 60 comprises a rubberized, fabric or plastic sheet 61 folded over the cable 13 and fastened together on the tail portion 62. This type fairing is lightweight, holds its shape better, and offers a more streamlined shape when compared to the hairy fairing 50. Flag fairings 60 also can generally be reeled onto a drum without significant damage to either the fairings or adjacent cables and can also provide effective strum attenuation, or weakening in intensity.

However, due to the low pressure region 103 associated with maximum fluid velocity at the sides 63 and 64 of the cable 13 and the high pressure region 65 in the wake of cable 13, the flexible flag fairing 60 is susceptible to “ballooning,” in which the sides of fairing 60 will pull away from cable 13 and expand to a much wider cross-section (not shown). Alternatively, flexible flag fairings 60 may assume an asymmetrical shape, deforming to one side of cable 13, as in the shape of a highly cambered airfoil, generating unacceptably high lift forces as a result of this asymmetry. In either case, a significant degradation in drag reduction effectiveness occurs. Depending upon the flexibility of the material used for a flag fairing 60 and the resulting degree of profile distortion, the associated drag coefficient can be as low as 0.4 or as high as 1.0.

As its name implies, the rigid fairing is made from rigid materials, such as hard plastic. Rigid fairings generally offer a lower drag coefficient than flexible fairings since they do not flex or change their shapes in the water, thus keeping the area exposed to the oncoming water flow relatively constant. Additionally, rigid fairings also offer more control in achieving a streamlined shape, as they are typically extruded to have a specific profile.

A major disadvantage with rigid fairings is that they are not as easy to store as are flexible fairings. Rigid fairings are prone to crushing if spooled onto a drum under subsequent layers of cable, so they generally have to be removed from the cable prior to spooling. As their constant shape is critical to their ability to reduce drag, the possibility of crushing when spooled onto a drum is a major disadvantage to the use of rigid fairings. Further, their stiff edges do not give way under compression like those of a flexible fairing and can cut into or otherwise damage adjacent cables and fairings under the weight of the spooled cable.

One type of rigid fairing is a tail-only, or strap-on fairing 70, as shown in FIG. 8A, made of a hard plastic extruded into an airfoil shape and affixed to cable 13 with attachment means 71 comprising a plurality of clips attached to the fairing 70 and surrounding the cable 13. This fairing type offers a drag coefficient of 0.2 to 0.3, which is lower than many or all of the flexible fairings. For design versatility, this fairing style is offered with both a solid tail 72, as shown in FIG. 8A, or hollow tail 73, as shown in FIG. 8B. The major disadvantage to this style fairing is that, as noted above, it cannot be stored on the drum without damage to the fairing or adjacent cables.

Close in shape to the preferable NACA0025 airfoil profile (C_{D}≈0.10) is the Odim-Spectrum TufNose fairing 80, as shown in FIG. 9, with a drag coefficient of approximately 0.25. This fairing 80 is a multi-piece, solid plastic fairing that can be snapped together, forming an opening 82 passing through the fairing, thus permitting the fairing to slip over a cable 13. However, this fairing 80 possesses the same disadvantages of the other rigid, solid fairings, namely the susceptibility to deformation and the possibility of causing damage to adjacent fairings or cables if stored in multiple wraps on a reel.

Fairings spooled onto drums or reels undergo a myriad of forces, including compressive forces resulting from subsequent layers of spooled cable as well as in-line tensions resulting from pulling the heavy cables and attached equipment from under the surface of the water. Fairings also have to be able to withstand stresses incurred when cables are left on drums for weeks at a time. Therefore, it is important that the fairing material does not undergo creep, a phenomenon in which sustained loads cause the material's shape to undergo permanent deformation.

Hence, there exists a need to improve fairing technology in order to achieve the low drag coefficient of rigid fairings without their storage problems.

### BRIEF SUMMARY OF THE PREFERRED EMBODIMENT OF THE INVENTION

The problems noted above are solved in large part by a fairing, made in accordance with the preferred embodiment of the present invention, that combines the benefits of flexible and rigid fairings. Accordingly, the preferred fairing is made from a material that makes the fairing rigid enough to achieve the superior hydrodynamic performance of rigid fairings, but flexible enough to be stored on the cables when reeled onto drums without incurring damage to itself or causing damage to adjacent components. Further, the preferred fairing is made from a material that, after being deformed during storage perhaps for weeks at a time, regains its original shape within time for use once it is unreeled, preferably within two hours, and more preferably, within 30 minutes.

### BRIEF DESCRIPTION OF THE DRAWINGS

For a detailed description of the preferred embodiments of the invention, reference will now be made to the accompanying drawings in which:

FIG. 1A shows a side view of a ship towing a cable with a horizontal offset;

FIG. 1B shows a front view of a ship towing a cable with a horizontal offset;

FIG. 2 shows a cross-sectional view of water flowing around a cable;

FIG. 3 shows a cross-sectional view of water flowing around a streamlined object;

FIG. 4 shows a front view of a cable passing through water and undergoing strumming;

FIG. 5A shows a top view of a ship and cabling with large drag forces and smaller lateral separations;

FIG. 5B shows a top view of a ship and cabling with smaller drag forces and larger lateral separations,

FIG. 6 shows a cross-sectional view of a prior art hair fairing;

FIG. 7 shows a cross-sectional view of a prior art flag fairing;

FIG. 8A shows a cross-sectional view of a prior art tail-only fairing with a solid tail;

FIG. 8B shows a cross-sectional view of a prior art tail-only fairing with a hollow tail;

FIG. 9 shows a cross-sectional view of a prior art TufNose fairing; and

FIG. 10 shows a cross-sectional view of a preferred embodiment of the present invention.

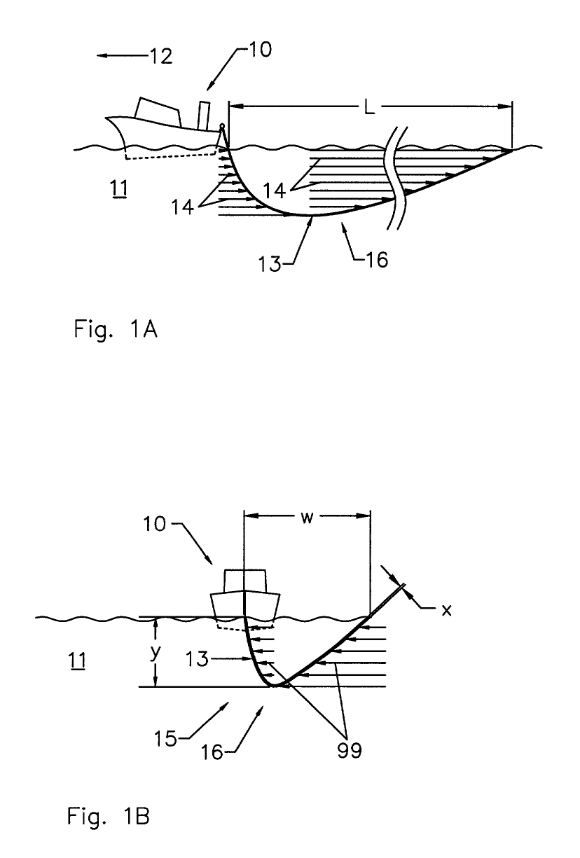

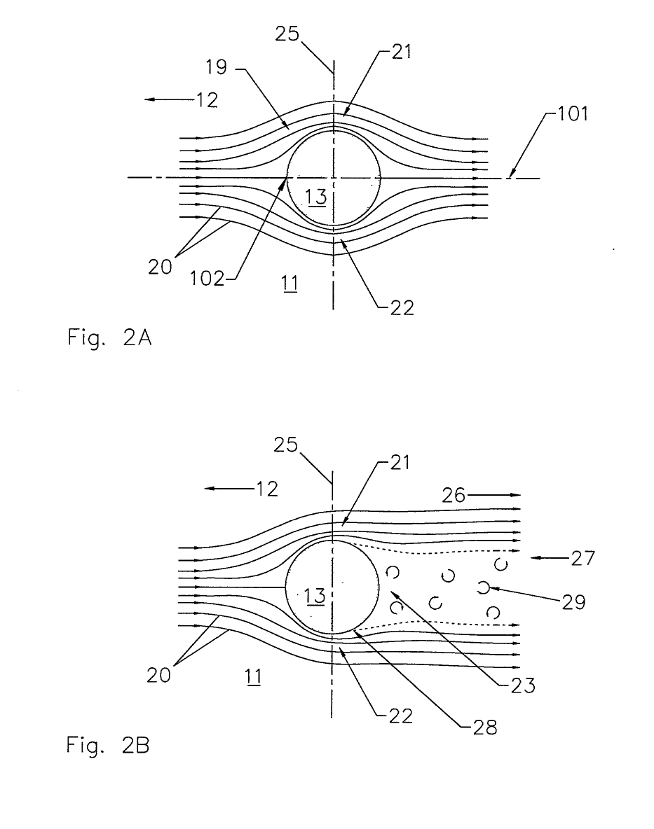

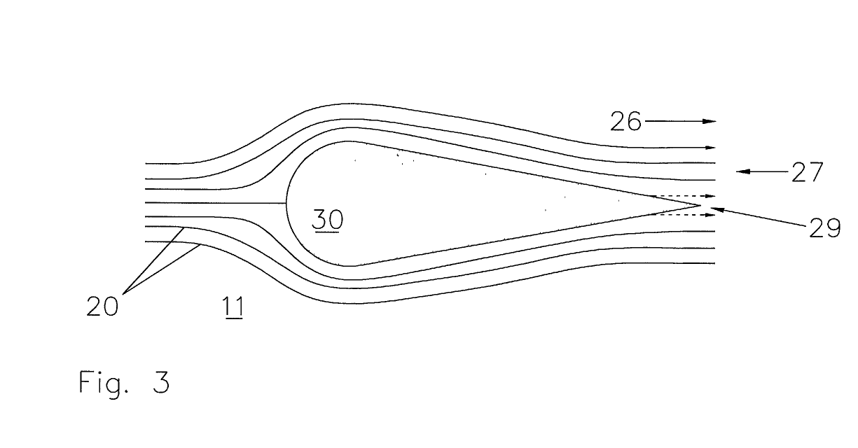

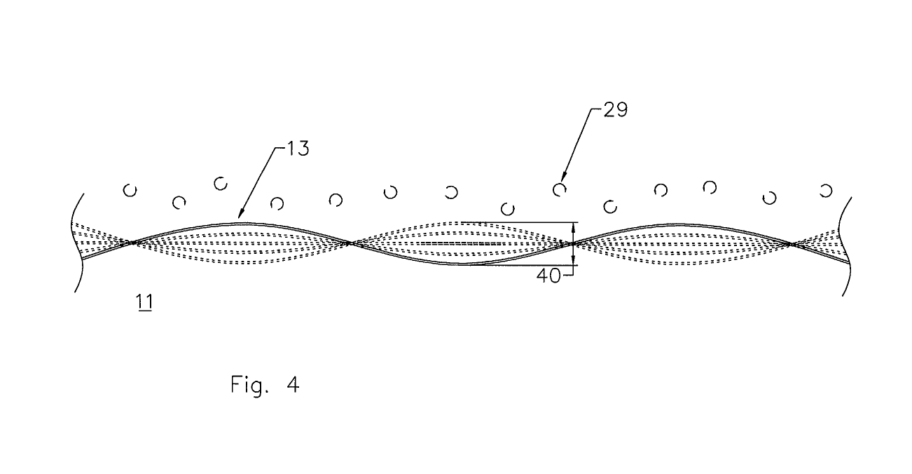

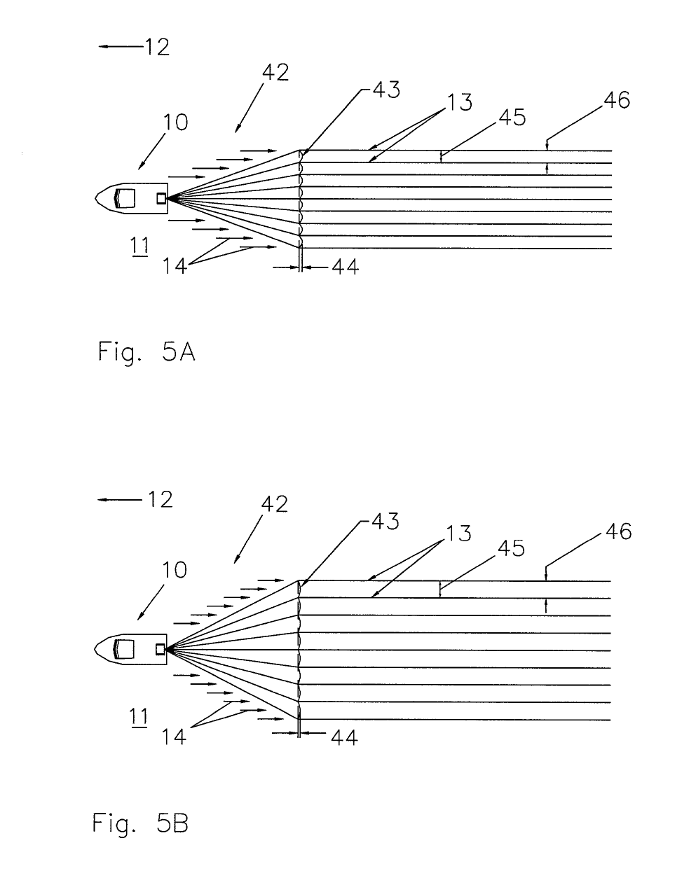

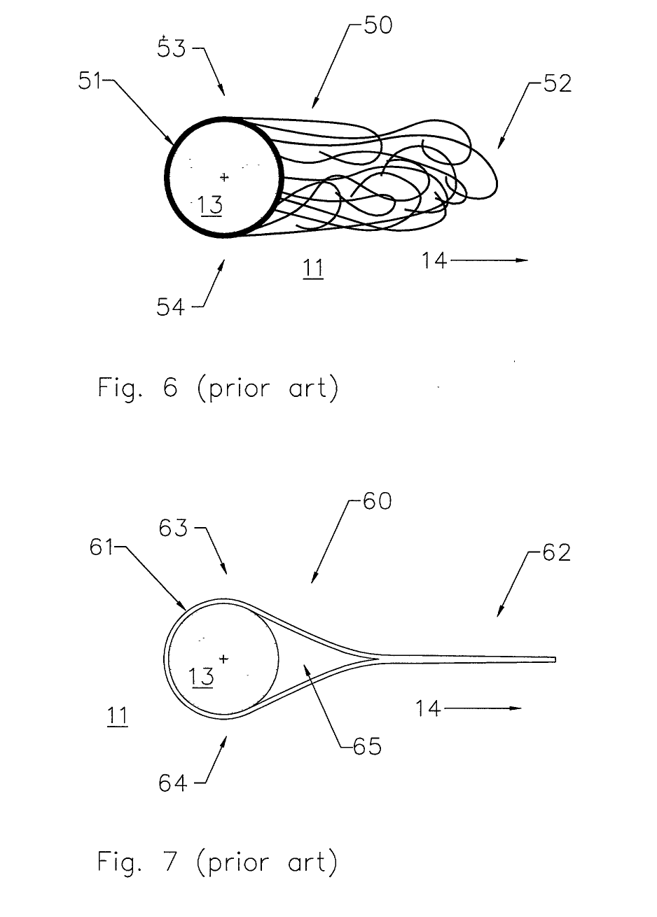

### DETAILED DESCRIPTION OF THE PREFERRED EMBODIMENTS

In accordance with the preferred embodiment of the present invention, a fairing is made so as to combine the benefits of flexible and rigid fairings. Accordingly, the preferred fairing is made from a material that makes the fairing rigid enough to achieve the superior hydrodynamic performance of rigid fairings, but flexible enough to be stored on the cables when reeled onto drums. Further, the preferred fairing is made from a material that, after being deformed during storage perhaps for weeks at a time, springs back to its original shape within a few minutes or hours. In one embodiment, the fairing will return to its original shape within 30 minutes. In another embodiment, the fairing returns to its original shape within two hours.

Any material that affords the fairing the above-identified features is within the scope of this disclosure. More specifically, but without limitation, the material used in accordance with the preferred embodiment of the present invention has a specific gravity close to that of seawater with a slight negative buoyancy, and therefore ranging between approximately 1.0 and 1.2 gr/cc, a hardness between approximately 85 and 100 Shore, a tensile strength between approximately 30 and 45 MPa, a tensile stress at 300% elongation between approximately 8.3 and 30 MPa, an elongation at break between approximately 400 and 700%, a tensile set at break between approximately 45 and 70%, a tear strength between approximately 80 and 200 kN/m, and an abrasion resistance between approximately 25 and 75 mg. Preferably, the material comprises a polyether-based thermoplastic polyurethane. Examples of suitable materials include BASF Elastollan® 1185A, 1195A or other suitable materials meeting the desired materials properties with satisfactory, abrasion resistance that are also hydrolytically stable.

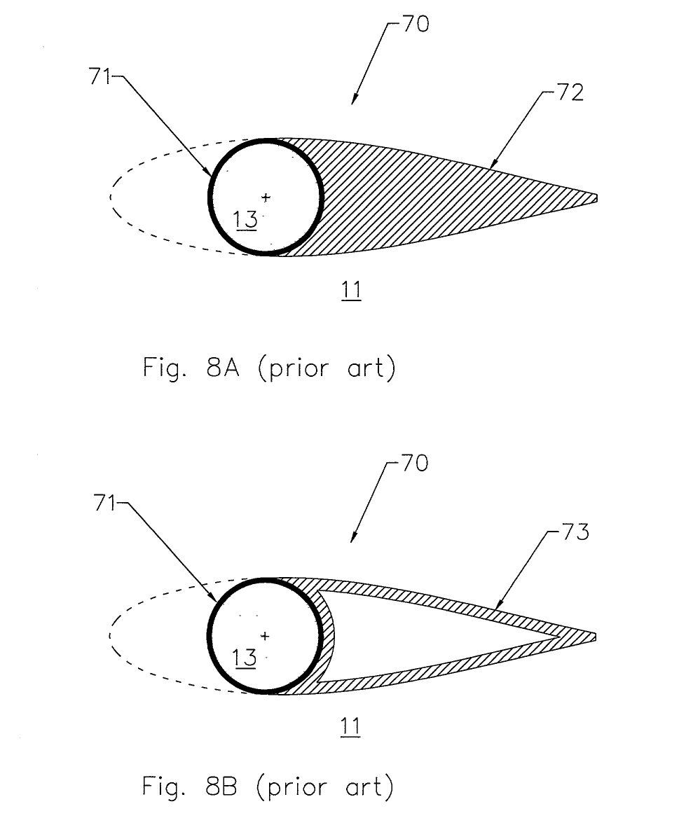

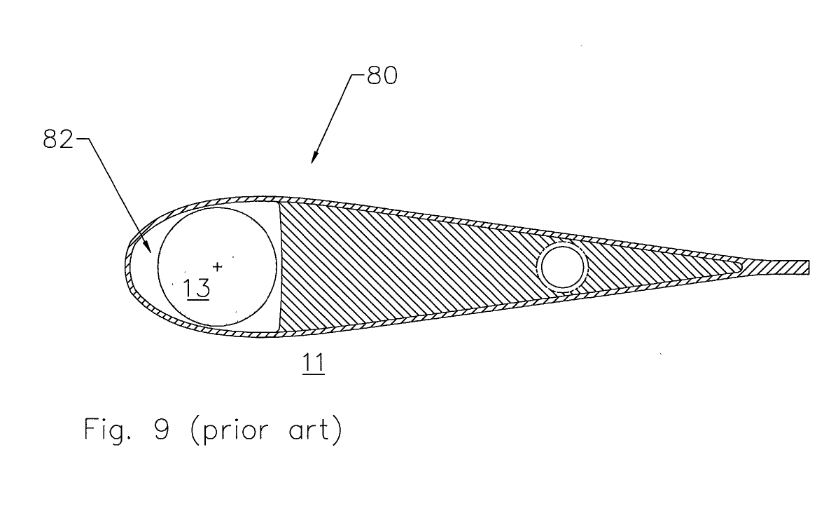

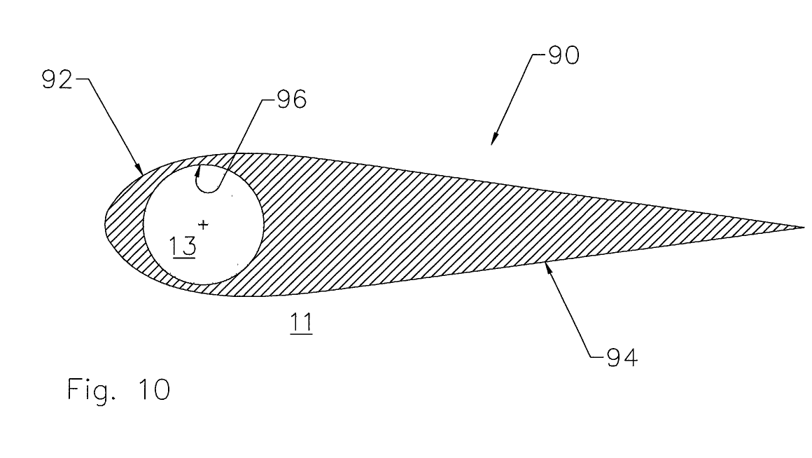

Various manufacturing methods, such as extrusion and molding, can be utilized to manufacture fairings in accordance with a preferred embodiment of the present invention. Fairings may be formed as one piece or as multiple pieces. FIG. 10 shows a preferred embodiment of the present invention. Referring to FIG. 10, fairing 90 is shown as a one-piece fairing having a rounded or leading edge portion 92 and a tapered or trailing edge portion 94. The fairing shape may be in accordance with the NACA0025 standard or various other shapes. As a one-piece fairing, the fairing 90 includes a hole 96 formed therethrough permitting the fairing to slip over a cable 13. Alternatively, the fairing 90 may be formed from multiple pieces coupled together (e.g., separate leading and trailing edge portions) and have any desirable mechanisms for attachment to a marine cable including, as shown in FIG. 10, a hole formed in the leading edge portion or a plurality of clips retaining the cable against an exposed, rounded leading edge portion, such as shown in FIG. 8B. Moreover, the fairing 90 may be either solid or hollow.

Numerous variations and modifications will become apparent to those skilled in the art once the above disclosure is fully appreciated. For example, fairings may have either open or closed ends, may swivel about or slide along a cable, and may be designed asymmetrically to account for varying angles of attack.

What is claimed is:

1. A marine fairing having a leading edge and a tail portion extending from the leading edge, said fairing made from a material made from a material having a specific gravity of approximately 1.0 to 1.2 gr/cc.

2. The fairing of claim 1 wherein said material has a tensile stress at 300% elongation of approximately 8.3 to 30 Mpa.

3. The fairing of claim 1 wherein said material has an elongation at break of approximately 400 to 700 percent.

4. The fairing of claim 1 wherein said material has a tensile set at break of approximately 45 to 70 percent.

5. The fairing of claim 1 wherein said material has a tear strength of approximately 80 to 200 kN/m.

6. The fairing of claim 1 wherein said material has a tensile stress at 300% elongation of approximately 8.3 to 30 MPa, an elongation at break of approximately 400 to 700 percent, a tensile set at break of approximately 45 to 70 percent, and a tear strength of approximately 80 to 200 kN/m.

7. The fairing of claim 1 wherein said material is made of polyether-based thermoplastic polyurethane.

8. The fairing of claim 1 wherein said fairing deforms while stowed and not in use, but returns to at least approximately its original shape within two hours.

9. The fairing of claim 1 wherein said fairing deforms while stowed and not in use, but returns to at least approximately its original shape within 30 minutes.

10. The fairing of claim 1 wherein said fairing is made from a single piece of material.

11. The fairing of claim 1 wherein said fairing is made from a multiple pieces of material.

12. A marine fairing having a leading edge and a tail portion extending from the leading edge, said fairing made from a material made from a material a tensile stress at 300% elongation of approximately 8.3 to 30 MPa.

13. The fairing of claim 12 wherein said material has a specific gravity of approximately 1.0 to 1.2 gr/cc.

14. The fairing of claim 12 wherein said material has an elongation at break of approximately 400 to 700 percent.

15. The fairing of claim 12 wherein said material has a tensile set at break of approximately 45 to 75 percent.

16. The fairing of claim 12 wherein said material has a tear strength of approximately 80 to 200 kN/m.

17. The fairing of claim 1 wherein said material has a specific gravity of approximately 1.0 to 1.2 gr/cc, an elongation at break of approximately 400 to 700 percent, a tensile set at break of approximately 45 to 70 percent, and a tear strength of approximately 80 to 200 kN/m.

18. The fairing of claim 12 wherein said material is made of polyether-based thermoplastic polyurethane.

19. The fairing of claim 12 wherein said fairing deforms while stowed and not in use, but returns to at least approximately its original shape within two hours.

20. The fairing of claim 12 wherein said fairing deforms while stowed and not in use, but returns to at least approximately its original shape within 30 minutes.

21. The fairing of claim 12 wherein said fairing is made from a single piece of material.

22. The fairing of claim 12 wherein said fairing is made from a multiple pieces of material.

23. A marine fairing having a leading edge and a tail portion extending from the leading edge, said fairing made from a material made from a material having an elongation at break of approximately 400 to 700 percent.

24. The fairing of claim 23 wherein said material has a specific gravity of approximately 1.0 to 1.2 gr/cc.

25. The fairing of claim 1 wherein said material has a tensile stress at 300% elongation of approximately 8.3 to 30 Mpa.

26. The fairing of claim 1 wherein said material has a tensile set at break of approximately 45 to 70 percent.

27. The fairing of claim 1 wherein said material has a tear strength of approximately 80 to 200 kN/m.

28. The fairing of claim 23 wherein said material has a specific gravity of approximately 1.0 to 1.2 gr/cc, a tensile stress at 300% elongation of approximately 8.3 to 30 MPa, a tensile set at break of approximately 45 to 70 percent, and a tear strength of approximately 80 to 200 kN/m.

29. The fairing of claim 23 wherein said material is made of polyether-based thermoplastic polyurethane.

30. The fairing of claim 23 wherein said fairing deforms while stowed and not in use, but returns to at least approximately its original shape within two hours.

31. The fairing of claim 23 wherein said fairing deforms while stowed and not in use, but returns to at least approximately its original shape within 30 minutes.

32. The fairing of claim 23 wherein said fairing is made from a single piece of material.

33. The fairing of claim 23 wherein said fairing is made from a multiple pieces of material.

34. A marine fairing having a leading edge and a tail portion extending from the leading edge, said fairing made from a material made from a material having a tensile set at break of approximately 45 to 70 percent.

35. The fairing of claim 34 wherein said material has a specific gravity of approximately 1.0 to 1.2 gr/cc.

36. The fairing of claim 34 wherein said material has a tensile stress at 300% elongation of approximately 8.3 to 30 Mpa.

37. The fairing of claim 34 wherein said material has an elongation at break of approximately 400 to 700 percent.

38. The fairing of claim 34 wherein said material has a tear strength of approximately 80 to 200 kN/m.

39. The fairing of claim 34 wherein said material has a specific gravity of approximately 1.0 to 1.2 gr/cc, a tensile stress at 300% elongation of approximately 8.3 to 30 MPa, an elongation at break of approximately 400 to 700 percent, and a tear strength of approximately 80 to 200 kN/m.

40. The fairing of claim 34 wherein said material is made of polyether-based thermoplastic polyurethane.

41. The fairing of claim 34 wherein said fairing deforms while stowed and not in use, but returns to at least approximately its original shape within two hours.

42. The fairing of claim 34 wherein said fairing deforms while stowed and not in use, but returns to at least approximately its original shape within 30 minutes.

43. The fairing of claim 34 wherein said fairing is made from a single piece of material.

44. The fairing of claim 34 wherein said fairing is made from a multiple pieces of material.

45. A marine fairing having a leading edge and a tail portion extending from the leading edge, said fairing made from a material made from a material having a tear strength of approximately 80 to 200 kN/m.

46. The fairing of claim 45 wherein said material has a specific gravity of approximately 1.0 to 1.2 gr/cc.

47. The fairing of claim 45 wherein said material has a tensile stress at 300% elongation of approximately 8.3 to 30 Mpa.

48. The fairing of claim 45 wherein said material has an elongation at break of approximately 400 to 700 percent.

49. The fairing of claim 45 wherein said material has a tensile set at break of approximately 45 to 70 percent.

50. The fairing of claim 45 wherein said material has a specific gravity of approximately 1.0 to 1.2 gr/cc, a tensile stress at 300% elongation of approximately 8.3 to 30 MPa, an elongation at break of approximately 400 to 700 percent, and a tensile set at break of approximately 45 to 70 percent.

51. The fairing of claim 45 wherein said material is made of polyether-based thermoplastic polyurethane.

52. The fairing of claim 45 wherein said fairing deforms while stowed and not in use, but returns to at least approximately its original shape within two hours.

53. The fairing of claim 45 wherein said fairing deforms while stowed and not in use, but returns to at least approximately its original shape within 30 minutes.

54. The fairing of claim 45 wherein said fairing is made from a single piece of material.

55. The fairing of claim 45 wherein said fairing is made from a multiple pieces of material.
